(19) United States
(12) Patent Application Publication
(10) Pub. No.: US 2016/0210588 A1
(43) Pub. Date: Jul. 21, 2016

(54) METHOD AND APPARATUS FOR ACQUIRING DETAILED DELIVERY TRACKING

(71) Applicant: Progressive Computer Services, Inc., Philadelphia, PA (US)

(72) Inventors: Perry WHEELOCK, Parkville, MD (US); Howard J. WEISS, Washington Crossing, PA (US); Nicholas SWEET, Downingtown, PA (US); Chandra ALLRED, Glen Mills, PA (US); Martin BECKER, New Hope, PA (US)

(21) Appl. No.: 15/094,440

(22) Filed: Apr. 8, 2016

Related U.S. Application Data
(63) Continuation of application No. 14/835,318, filed on Aug. 25, 2015.
Application No. 14/835,318 is a continuation of application No. 14/078,574, filed on Nov. 13, 2013.
(60) Provisional application No. 61/762,112, filed on Feb. 7, 2013.

(51) Int. Cl. G06Q 10/08; H04W 4/14

(52) U.S. Cl. CPC G06Q 10/0833; H04W 4/14

(57) ABSTRACT

Systems and methods are directed to tracking and displaying status information. First delivery status information is received, from a shipment management server (SMS), by one or more processors associated with a retail location. The first delivery status information includes information regarding cartons to be delivered to the retail location in a first delivery. The information is derived from a first advance shipping notice. Other delivery status information is received which is derived from a second advance shipping notice. The various delivery status information is processed and simultaneously displayed on a display screen.

### CROSS-REFERENCE TO RELATED APPLICATIONS

This application is a continuation of pending U.S. patent application Ser. No. 14/835,318, filed on Aug. 25, 2015, which is a continuation of U.S. patent application Ser. No. 14/078,574, filed on Nov. 13, 2013, which claims priority to U.S. Provisional Patent Application No. 61/762,112, filed on Feb. 7, 2013. Each of the above-identified patent applications are incorporated herein by reference.

### BACKGROUND OF THE INVENTION

Embodiments of the present invention relate generally to tracking shipments of retail inventory. More specifically, embodiments of the present invention relate to providing carton- and item-level delivery information to management and staff at retail locations.

Immense amounts of goods and cargo are shipped across the United States each day. Retailers have established increasingly complex supply chains to efficiently manage these shipments and deliveries. A large infrastructure of interconnected service providers, including manufacturers, distributors, warehouses, and third party logistics services (3PL), has been established to assist in the shipment process.

Goods are typically packaged into shipments based upon their stock-keeping units (SKUs). Individual items are packed into cartons, which may each contain items of a single SKU or multiple different SKUs. Cartons may then be grouped into pallets and placed on vehicles of varying size and transportation mode for transport by and between the various service providers.

Due to the packaging of individual items into cartons, and cartons into pallets, it is difficult to track item-level detail of in-transit orders and shipments. While cartons are often scanned at departure and arrival by the various service providers, such scans do not provide accurate item-level detail. To address this deficiency, some service providers add Radio Frequency Identification (“RFID”) tags to individual items as they traverse the supply chain. RFID tags allow item-level tracking of individual items when such items pass through RFID reader portals. However, RFID tags suffer from the drawback that they are still relatively expensive to include in each item of a shipment, especially for low-cost and/or low-margin items. Furthermore, RFID only addresses issues related to scanning, not the overall need for communication regarding the shipment. Therefore, for many applications, RFID is neither economically sensible nor a complete solution.

Accordingly, it is desirable to provide methods and systems to provide accurate carton-level and item-level detail of deliveries without the use of RFID tags. It is further desirable to provide such detailed delivery information to retail store management and staff for store operation purposes.

### SUMMARY OF THE INVENTION

In one embodiment, systems and methods for carton- and item-level tracking of deliveries to retail locations in a supply chain are described. A central shipment management system receives over a network, from one or more retail distribution centers associated with a plurality of retail locations, advanced shipping notice information describing one or more shipments of pluralities of cartons to a pool. The central computer system also receives, from the retailer or distribution center, product information including category and description information for items contained in a shipment to at least one retail location of the retailer. The received advance shipping notice information and the product information are processed. The processing applies one or more business logic rules to determine an estimated delivery date of the shipment to the at least one retail location. A portal accessible over the network by associates of the retail location is provided. The portal displays the item and carton information and the estimated delivery date associated with the item and carton information. Information regarding deliveries is updated based upon information from the pool provider.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings aspects of embodiments that are presently preferred. It should be understood, however, that the invention is not limited to the precise arrangements and instrumentalities shown.

FIG. 1 is a simplified exemplary diagram of a supply-chain environment;

FIG. 2 is a simplified exemplary diagram of computing platforms in the exemplary supply-chain environment of FIG. 1;

FIG. 3 is an exemplary graphical user interface (“GUI”) of a retail store interface screen according to one embodiment of the present invention;

FIG. 4 is a portion of the exemplary GUI of FIG. 3 displaying SKU-level and carton information for a selected category;

FIG. 5 is an exemplary delivery report according to a preferred embodiment of the present invention;

FIG. 6 is an exemplary placard for verifying presence at a location according to a preferred embodiment of the present invention;

FIG. 7A is an exemplary GUI for carton-based delivery according to a preferred embodiment of the present invention;

FIG. 7B is an exemplary GUI showing carton shortfall for a delivery according to a preferred embodiment of the present invention;

FIG. 8A is an exemplary GUI for carton-based delivery showing a wrong carton scan according to a preferred embodiment of the present invention;

FIG. 8B is an exemplary GUI for associate delivery verification according to a preferred embodiment of the present invention;

FIG. 9 is a sequence diagram for an exemplary delivery scenario for delivery originating from a single distribution center;

FIG. 10 is a sequence diagram for an exemplary delivery scenario for a delivery to a retail store comprising cartons originating at two different distribution centers;

FIG. 11 illustrates an example query string and format for an XML response for a listing of the deliveries for a store;

FIG. 12 illustrates an example query string and format for an XML response for a listing of the categories of goods being delivered to a store on a particular day;

FIG. 13 illustrates an example query string and format for an XML response for a listing of SKUs to be delivered on a specific day for a specified category; and

FIG. 14 illustrates an example query string and format for an XML response for a listing of cartons to be delivered on a specific day for a specified category.

### DETAILED DESCRIPTION OF THE PREFERRED EMBODIMENTS

Certain terminology is used in the following description for convenience only and is not limiting. The words “right”, “left”, “lower”, and “upper” designate directions in the drawings to which reference is made. The terminology includes the above-listed words, derivatives thereof, and words of similar import. Additionally, the words “a” and “an”, as used in the claims and in the corresponding portions of the specification, mean “at least one.”

The present disclosure relates to methods and systems of carton- and item-level tracking of supply chain shipments. In a modern supply chain, multiple service providers cooperate with one another to provide necessary materials to their proper locations, at the correct times. Orders and re-orders for specific retail locations are placed and fulfilled through the supply chain on a region or location-based level. Such orders and re-orders may be automatic, for example, where an inventory management system re-orders items that are low stock, or manual, such as where a request for a particular out of stock item has been received.

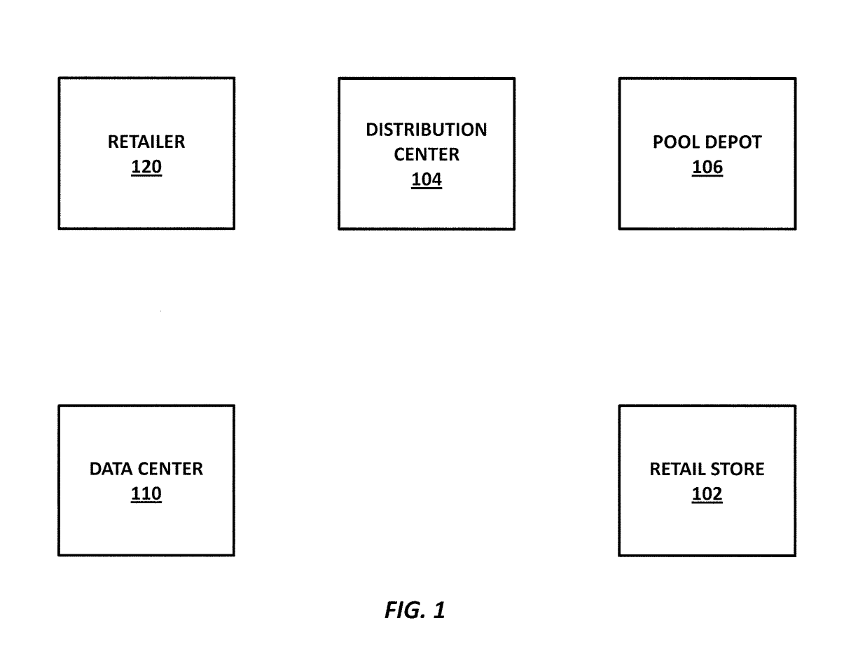

Referring to the drawings in detail, wherein like reference numerals indicate like elements throughout, FIG. 1 is a simplified exemplary diagram of a supply chain environment. At a headquarters or operations location, retailer 120 arranges for production or sourcing of products for eventual sale in geographically dispersed retail stores 102. Retailer 120 may store received or manufactured products in one or more distribution centers 104. It is to be understood that the physical separation or combination of functions such as operations, finance, and distribution for the retailer are exemplary and that they may be divided or combined in other ways within the scope of the invention.

When an order is to be fulfilled by a retailer 120 for a particular retail location 102, various components of the supply chain are mobilized to deliver the required items. In the simplified example of FIG. 1, retailer 120 contracts with a third party logistics provider (3PL or “pool”) 106 to make deliveries to retail locations 102. Each retailer 120 may use a single 3PL 106, or a combination of 3PLs, to perform their deliveries to all of the retail locations 102 of the retailer 120. As a result, a 3PL 106 is likely to service multiple retailers 120, making deliveries to a plurality of different retail locations 102 of those retailers 120.

In some embodiments, one or more additional intermediate supply chain components, such as central and regional distribution centers or warehouses 104 may be utilized in the freight shipment process. Such additional supply chain components may be integrated in the simplified system described herein without departing from the scope of this invention.

Retailer 120 may deploy trailers with numerous cartons destined for many different retail stores from distribution center 104 to the 3PL 106. Cartons delivered to the 3PL may preferably contain items of a single SKU, but may also contain multiple SKUs. At the 3PL 106, cartons may be repackaged into mixed cartons having a plurality of items with different SKUs, that are all intended for the same retail location 102. The 3PL 106 then delivers the mixed cartons to the proper retail location 102.

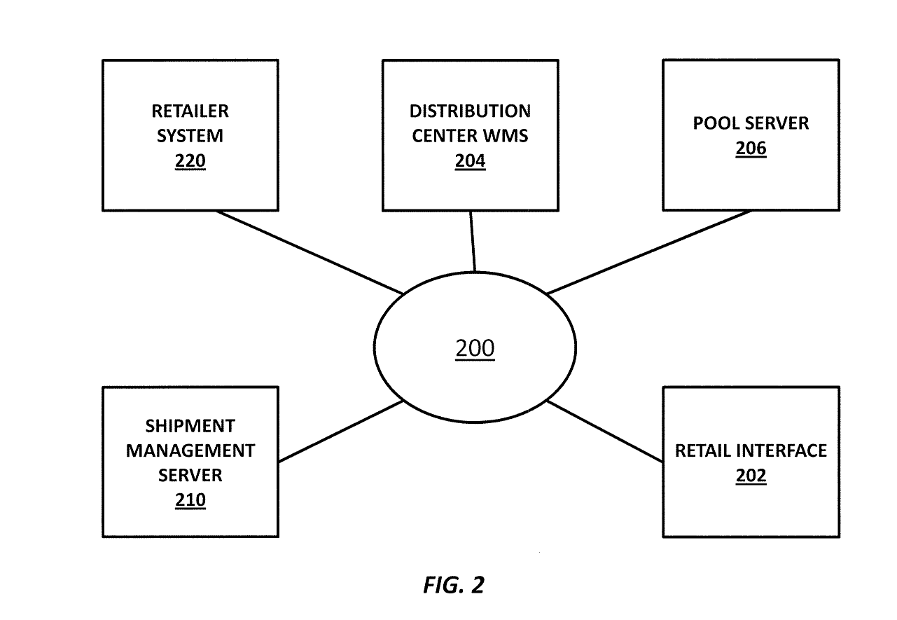

Referring now to FIGS. 1 and 2, when the retailer 120 initiates shipment of a trailer of cartons from a distribution center 104 to the 3PL 106, the contents of the shipment are described by an advance shipping notice (ASN). However, additional information relating to the shipment, such as order information, product description, physical characteristics, type of packaging, markings, carrier information, and configuration of goods within the transportation equipment may also be included in the ASN. In order for the ASN data to be more useful at the store level it may comprise from other sources, such as SKU-level product data from a retailer's inventory or financial systems 220.

Throughout this shipment process, data regarding the shipments is created, updated, and transmitted to a variety of recipients. Each member of the supply chain (e.g., the retailers 120, the retail distribution centers 104, the 3PLs 106 and the retail locations 102) is preferably communicatively coupled through a network 290 with a shipment management system (“SMS”) 210 at data center 110. The members of the supply chain transmit freight data to the SMS 210 via standard network protocols, such as AS2, SFTP, or the like. Other formats and protocols for transmitting data are well known to those skilled in the art.

The SMS 210 may be deployed, for example, on a physical or virtual server, or plurality of servers that are communicatively coupled to the network. In one embodiment, the SMS 210 is a cloud-based system, implemented for example, on the AMAZON WEB SERVICES platform (AMAZON WEB SERVICES is a registered trademark of Amazon.com). Preferably, the SMS 210 implements an n-tier structured server system. In the preferred embodiment, the network 290 is, or includes, the Internet. However, the network may be one or more distinct public networks, private networks, or any combination thereof without departing from the scope of this invention.

ASNs are preferably generated by WMS 204. ASNs are typically sent in an electronic format such as Electronic Data Interchange (EDI) or Extensible Markup Language (XML). Since the ASN is sent in advance of the shipment, the goal of an ASN is to provide information to the destination's receiving operations well in advance of delivery. Due to their focus on bulk shipment descriptions, ASNs are typically not completely accurate, and they generally do not provide any store-specific data that may directly be used by store operations. To provide additional value in the ASN, in a preferred embodiment, WMS 204 may use information received or retrieved from Retailer System 220 in creation of the ASN, such as SKU information for items within the shipment cartons.

In some embodiments, Retailer System 220 may produce ASNs or Retailer System 220 and WMS 204 may be combined. In other embodiments, Retailer System 220 may provide WMS functionality via interfaces at Distribution Centers 104, such as via a web browser or other application. WMS 204 may also utilize identification and data capture technology, such as barcode scanners, mobile computers, wireless LANs and potentially radio-frequency identification (RFID) to efficiently monitor the flow of products or cartons through the distribution center 104. It should be recognized that the functions of each system might be spread over multiple physical compute platforms, for instance, for allocation of dedicated resources to certain functions and/or for load balancing.

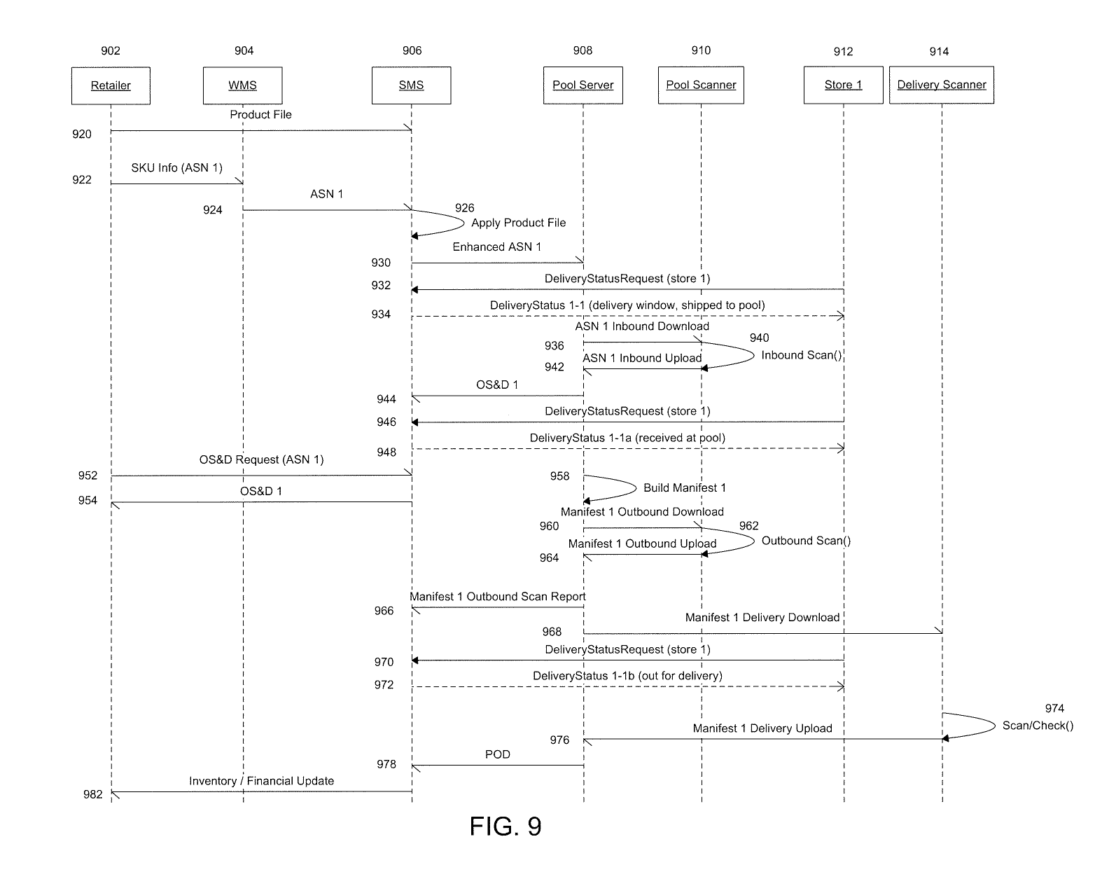

The ASN may then be transmitted from WMS 204, or Retailer System 220, over the network 290 to the SMS 210, where its contents are preferably stored in a database. The SMS 210 may process the ASN to augment it with additional information, such as product-level detail or descriptions. SMS 210 may enhance the ASN with information previously received from Retailer System 220, as described further below with respect to FIG. 9.

The SMS 210 transmits the ASN, or an enhanced version of the ASN, to the 3PL pool server 206. In addition to receiving information regarding incoming shipments, the 3PL pool server 206 may also be responsible for monitoring and/or controlling the movement and storage of items within the 3PL facility 106, and processing associated transactions, including shipping, receiving, putaway and picking.

At the 3PL 106, the cartons received from the distribution center 104 are received, sorted, and packed for delivery to the retail locations 102. Once cartons are ready for delivery from the 3PL facility 106 to the retail location 102, they are placed on a truck.

In a preferred embodiment, each carton to be delivered to a retail location 102 is assigned a unique carton identifier that will identify the carton throughout the delivery process. The carton identifier is encoded in a readable format, such as a barcode or the like. In addition, cartons are preferably coded to specific categories, each category corresponding to a good or item type (e.g., men's apparel, women's apparel, children's apparel, and the like).

Multiple scans of each cartons unique identifier may be performed as the cartons pass through the 3PL 106. Inbound scans are performed on freight received at the 3PL 106. The inbound scan is used to verify receipt of each carton at the 3PL 106, as well as detect cartons that were mistakenly shipped and to record information regarding damaged cartons. Outbound scans are scans of freight as it departs the facility of the 3PL 106. Outbound scans are used to verify that the appropriate cartons are loaded onto each delivery truck for its route. Store scans are scans of the cartons as they arrive at the delivery location, such as the retail location 102. Data from the 3PL pool server 206, including inbound scans, outbound scans, and store scans, are preferably transmitted to the SMS 210 for use in reporting and providing status to users at retailer 120 and retail stores 102.

When cartons delivered to the retail location 102 are mixed SKU cartons, when the mixed cartons are packed, each carton will preferably only contain goods associated with a single category assigned to the carton. For instance, if a carton is assigned to the men's apparel category, it will contain only men's apparel, but not men's footwear or men's accessories. In some embodiments, SMS 210 assigns categories to cartons based upon a combination of SKU information from Retailer System 220, the ASN from WMS 204, and a product file from Retailer System 220. In the case of cartons with SKUs from multiple categories, the carton category may be assigned based upon item count, value, or other rules.

The SMS 210 processes the data received from the Retailer System 220 and the Pool Server 206, and provides summarized information to employees and managers of the retail location 102 using the Retail Interface 202. Similar interfaces may provide aggregate or detailed information to retailer 120. This shipment and delivery date information provides store operations of the retail locations 102 with detailed information regarding inbound shipments. Such data may include information about size, identity, and timing of the shipments, allowing store operations to better plan and prepare for receipt of the shipments. Detailed knowledge regarding incoming shipments provides the advantage of allowing for planning for adequate staffing to receive, unpack, and shelve the shipments.

The SMS 210 may use data from multiple sources, and apply business logic, to forecast when particular items and/or cartons are to be delivered from 3PL 106 to the specific retail location(s) 102. As those skilled in the art will understand, transportation time for various transportation components of the supply chain varies depending on internal and external factors. Thus, the business logic estimates in-store date information based on rules taking into account data such as historical shipment time information, allowable work and delivery days, route information, and other factors. The forecast delivery date determined by the SMS 210 is intended to provide an accurate in-store date for the individual carton shipments to the retail locations 102. Additional factors, such as weather conditions, road conditions, traffic conditions, may also be considered automatically or by an operator who may manually update estimates via a user interface.

Preferably, the Retail Interface 202 is a web-based graphical user interface (“GUI”) accessible over the network 290 by a standard Internet browser or mobile application. In a preferred embodiment, the SMS 210 includes a web server configured to provide the Retail Interface 202 to users. However, in some embodiments, the web server may be a separate physical or virtual machine that is not part of the SMS 210.

The data stored by the SMS 210 provides the retail locations 102 the ability to track the status of shipments as the shipments move through the supply chain. Specifically, the Retail Interface 202 allows users at the retail location 102 to track specific shipments, cartons and SKUs. This information allows store staff to, for example, better prepare and staff for receiving, unpacking, and staging received merchandise in the store, and to provide an improved level of service to customers. Preferably, such store-specific delivery data is provided via the graphical user interface 300 on a real-time or substantially real-time basis.

Requests to the SMS 210 are made using the Retail Interface 202 over the network 290. For example, a user clicks on a web link in the Retail Interface 202, or enters data and submits an HTML form. Javascript in the web browser sends the request to a web server of the SMS 210. The web server is preferably a standard APACHE Web Server. The web server of the SMS 210, using PHP scripts, takes the request, formats a data request and sends it to an applied programming interface (“API”) running on the SMS 210. A PHP script running on the SMS 210 takes the data request and sends it to a program listening for such requests. The program processes the request by gathering the information from the database storing the freight data and generating an XML document with the requested data. This XML document is then passed back to the PHP script which took the data request, who then forwards it back to the PHP script on the web server. The Web Server then parses the information and sends the updated screen changes to the user's web browser. Thereafter, the web browser updates the Retail Interface 202 accordingly.

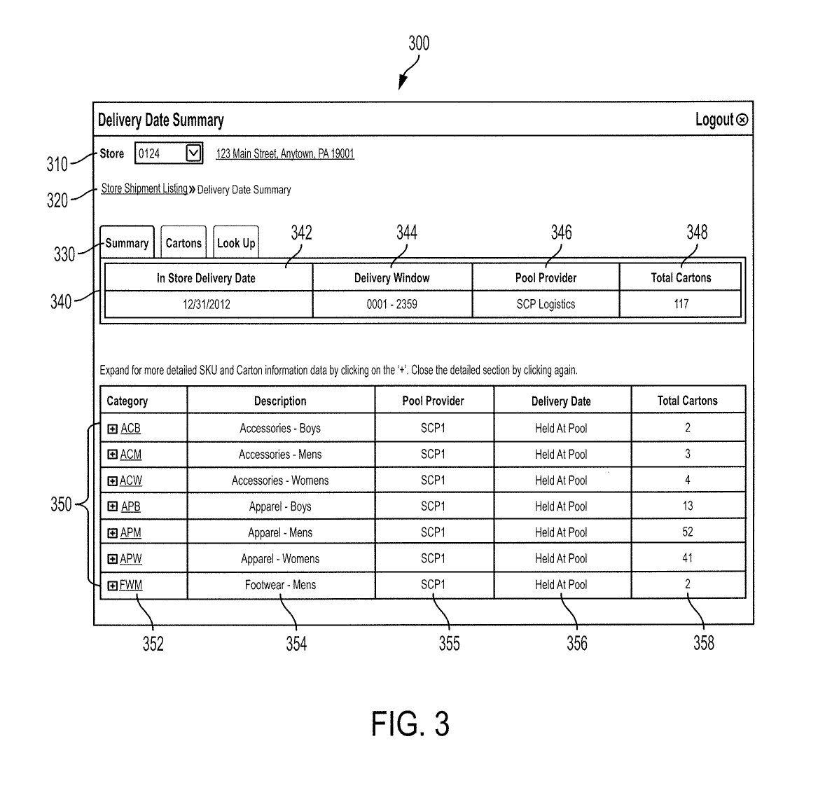

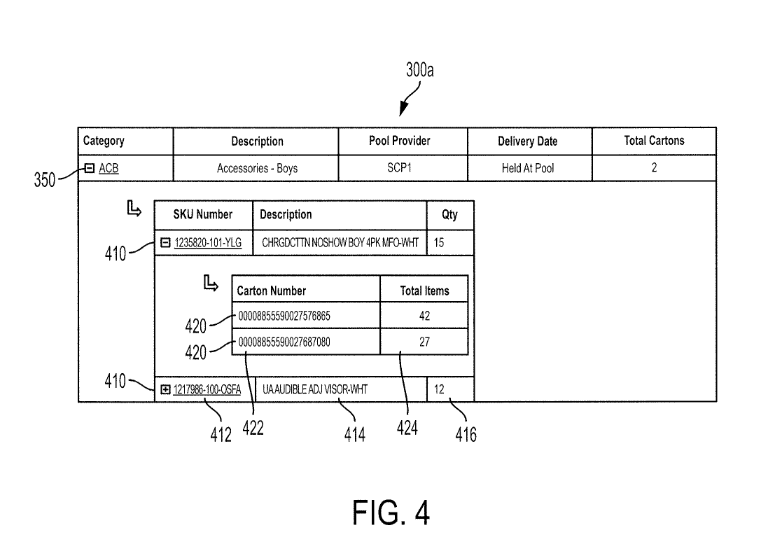

An exemplary graphical user interface for use with the Retail Interface 202 is described with reference to FIGS. 3-4. Employees and managers at retail location 102 access screens of the Retail Interface 202, such as screen 300, in order to review and interact with the shipment data stored by the SMS 210. Preferably, only authorized users may access the Retail Interface 202 by authenticating themselves using a user name and password, or the like, as is well known to those skilled in the art.

As shown in FIG. 3, the graphical user interface 300 displays store information 310, GUI navigation information 320, tabs 330 for selection of specific types of information, delivery information 340, and carton information 350. Delivery information may include in-store delivery date 342, delivery window 344, pool provider 346, and total number of cartons 348 due to the store. Carton information 350 may be organized based on the category identifiers 352. For each category identifier 352, a description of the category 354, a pool identifier 355, delivery information 356, and total number of cartons 358 may be provided.

A separate tab 330 may provide an entry form for search information, such as a SKU or carton number. The entered search terms may be transmitted by Retail Interface 202 to SMS 210 with corresponding results returned as a web page, for instance.

Selection of various elements of Retail Interface 202 may reveal additional information. FIG. 4 is an illustration of a portion 300a of Retail Interface 202 after certain selections are made. For instance, upon selection of a category 350 “ACB”, rows 410 for the individual SKUs within that category may be displayed. The individual SKUs 412, descriptions 414, and quantity of items 416, included in a particular category of the shipment can be viewed. In this example, when selecting a category 350, rows 410 for all SKUs 412 to be delivered will be displayed. Selection of a particular SKU 412 may reveal rows 420 for cartons containing items with that SKU. Carton number 422 and a total number of items 424 may be displayed for each carton. Thus, the user is able to determine the items being delivered for any particular category, and in which carton or cartons a desired item will be located upon delivery to the retail location 102.

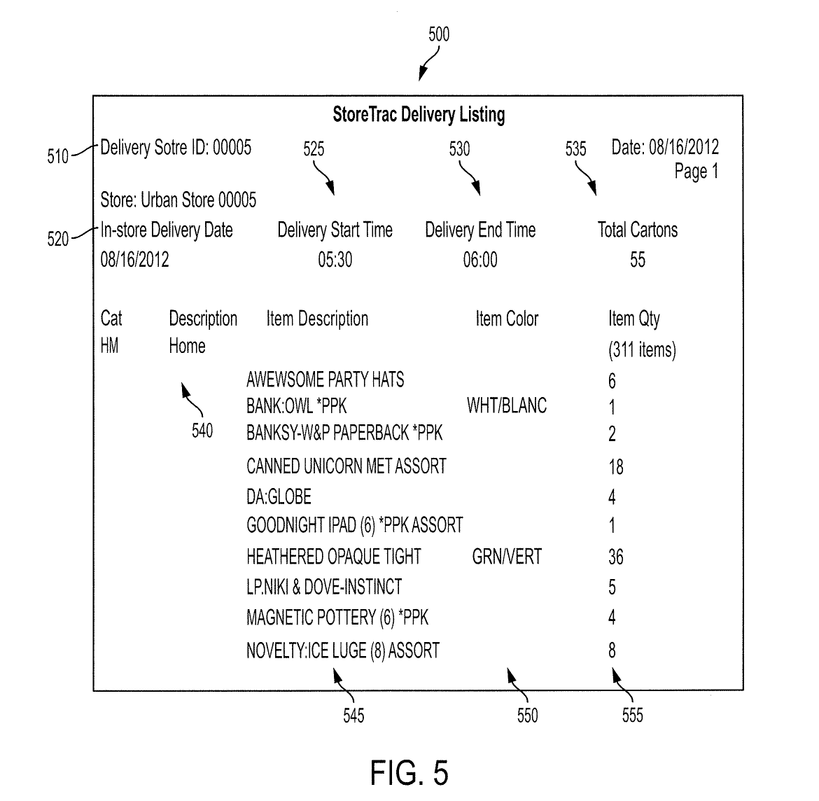

As shown in FIG. 5, upon completion of delivery by the 3PL 106 to the retail location 102, a delivery report 500 is generated. The exemplary delivery report of FIG. 5 summarizes the delivery by store number 510, delivery date 520, start time 525, end time 535, item category 540, style description 545, item color 550, and item quantity 555. Other descriptors of a delivery may be included in the delivery report 500 without departing from the scope of this invention.

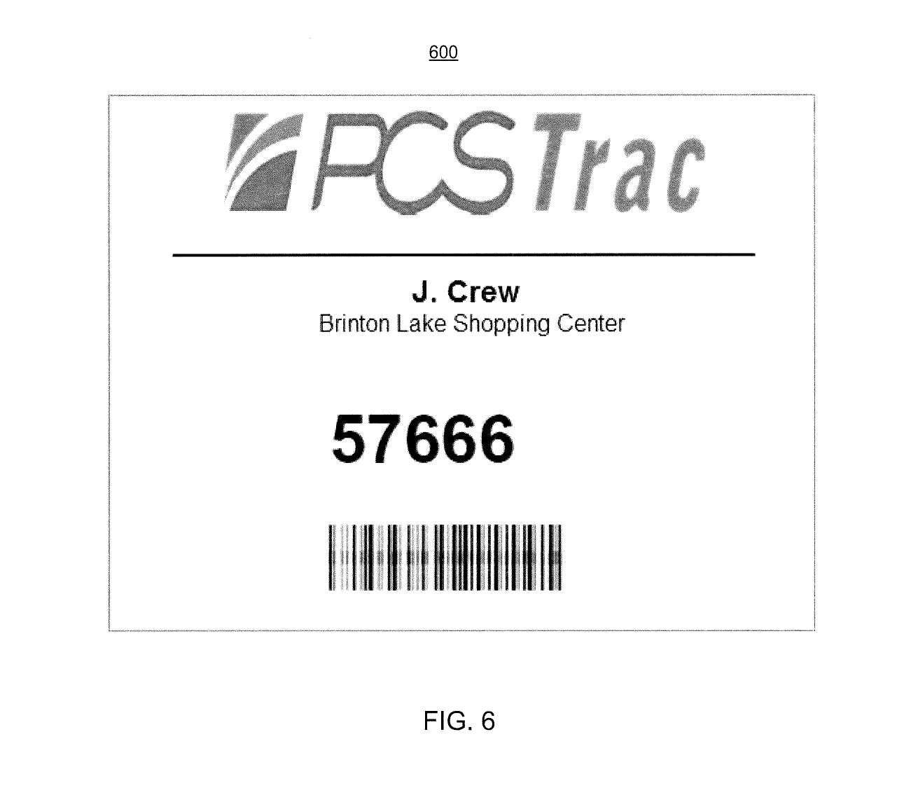

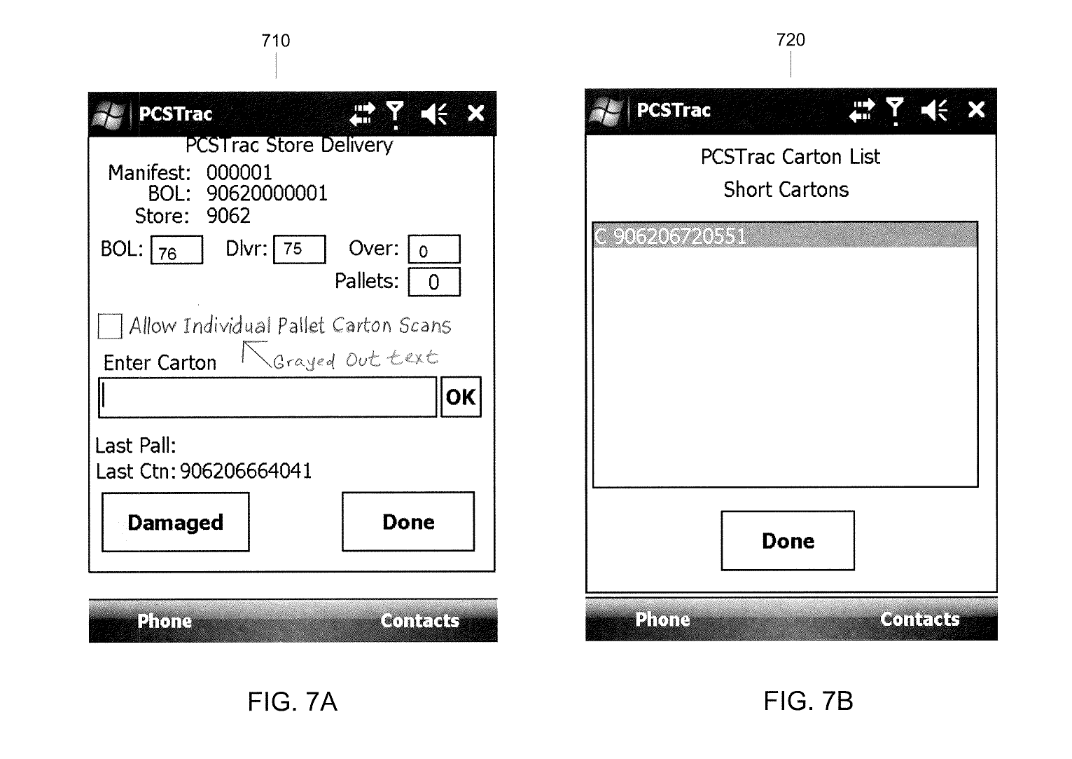

The delivery process will now be described in further detail with reference to FIGS. 6-7. FIG. 6 shows placard 600 used to verify presence at a particular location during a delivery scan. The placard 600 preferably includes identifying information such as retail location 102 name, location, an ID number, and a scannable barcode or the like. The barcode of placard 600 will preferably contain characters that may be scanned but may not be entered on the scanner keyboard manually so as to prevent entry of the code without physical presence in the location of the placard. Software or rules downloaded to the scanner may require that placard 600 be scanned at the beginning and end of a delivery, and that the elapsed time between scans be within certain limits to avoid triggering of exception conditions.

After scanning of placard 600, if required, the delivery person utilizes a mobile device, not shown, such as a mobile phone, tablet, or scanner, in performing the delivery process. The mobile device preferably has a wireless network connection for transmitting delivery data to the SMS 210. However, in alternate embodiments, the mobile device does not have a wireless network connection, and instead stores the delivery data and synchronizes it to the Pool Server 206 at a later time when a direct connection or network connection becomes available.

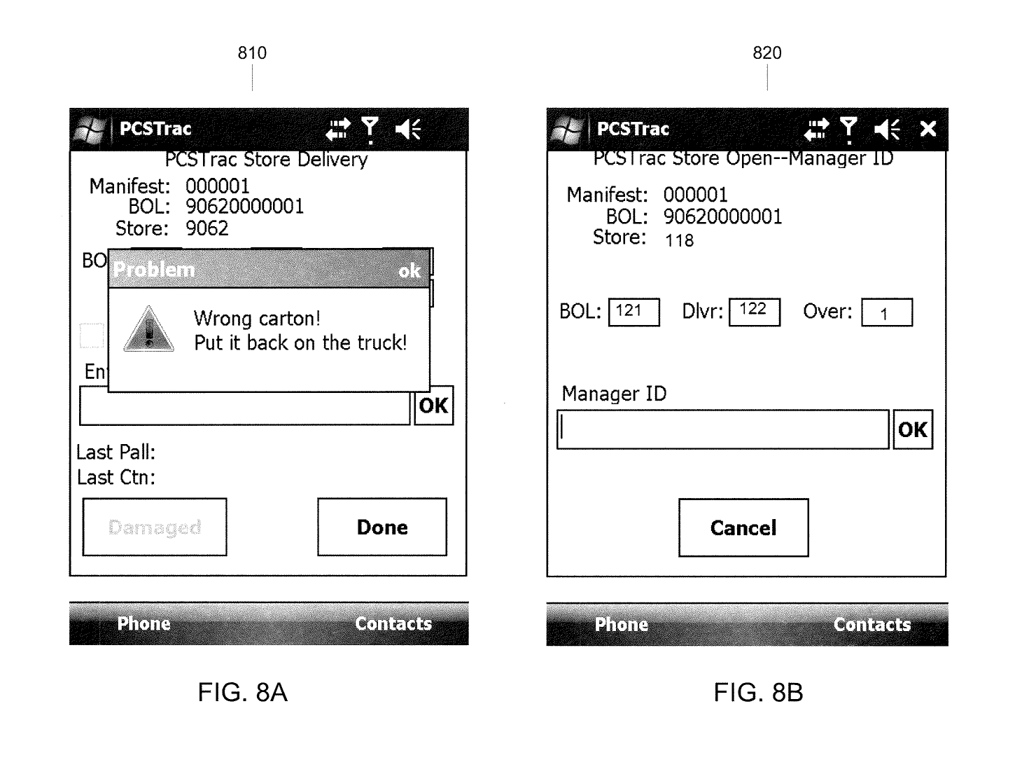

Referring to FIGS. 7A, 7B, 8A, and 8B, smart scanning features are provided to the delivery person based on the shipment information downloaded from the pool server 206. The delivery person scans each carton for the particular retail store 102 at delivery. As each carton is scanned, the unique carton ID of the scanned carton is displayed by the GUI 710. Bill of Lading information, carton information, and other delivery information may also be displayed by the GUI 710. In the preferred embodiment, the provider may indicate a carton as being damaged if physical damage to the carton is noted at time of delivery. The delivery person may finish the delivery scan by pressing a “Done” button. Upon completion of the scanning process, and optionally during the scanning process, the GUI 710 of FIG. 7A displays information such as total carton count, overages and shortages for the delivery.

The scanner, in combination with downloaded data, programs, or scripts, provides assistance to the delivery person in verifying delivery of the correct cartons, and only those cartons, to the retail store 102. FIG. 7B illustrates a GUI 720 displayed at an attempted close of delivery indicating a list of cartons that have not been found and/or scanned. This information prompts the delivery person to search the delivery vehicle or loading area for missing cartons. Similarly, FIG. 8A illustrates a GUI 810 alerting the delivery person of a scan of a carton ID that is not part of the delivery to the specific retail location 102. The delivery person is notified by the GUI to place the scanned carton back on the delivery vehicle for delivery to the correct store. Upon completing the scan, a store associate may use a verification GUI 820 of FIG. 8B to verify the delivery count on the provider's mobile device.

Exceptions in the delivery process may occur when the scan process did not follow a specified procedure. For example, an exception may occur if the provider's mobile device failed during delivery or if the provider failed to scan the placard 600 to enter or exit the store. These exceptions are segregated from the regular flow of Inventory Update, and “held” within the pool server 206 or SMS 210. In cases of exceptions, providers upload a delivery bill of lading to prove delivery since the scan data cannot validate actual receipt. Inventory control accesses the held files through Exception Management functionality and approves or disapproves the cartons.

FIG. 9 is a sequence diagram of a delivery scenario. It should be recognized that the sequence diagram represents one possible sequence of events for illustrative purposes. Many events may occur in different orders, or on more or fewer occasions. Furthermore, the sequence diagram of FIG. 9 illustrates interactions related to delivery of cartons from a single distribution center to a single retail store. It is to be understood that the systems and methods described herein are not limited to such scenarios. In practice, SMS 210 may manage shipments from numerous retailers through many distribution centers and pools to many retail locations. Objects 902-914 are used to describes groupings of functionality and are not intended to indicated a specific allocation of processes or hardware.

Prior to initiation of a shipment, retailer 902 transmits a Product File to SMS 906. The Product File may provide mappings from SKU numbers to product descriptions and/or categories. SMS 906 may use the Product File to enhance received ASNs with descriptive data for presentation to Retail Interface 202.

At 922, Retailer 902 transmits SKU information for products in the cartons of a shipment to Warehouse Management System (“WMS”) 904. WMS 904 may combine the SKU information with other information regarding the cartons in a planned delivery to create an Advance Shipping Notice (“ASN”). At 924, the ASN for a shipment is transmitted to SMS 906. In some embodiments, SKU information may be transmitted directly to SMS 906 for combination with a received ASN. As described above with respect to FIG. 2, Retailer 902 and WMS 904 functions may be combined or allocated amongst various platforms within the scope of the invention.

At 926, SMS 906 uses the product file received at 920 and the ASN received at 924 to create an enhanced ASN. The enhanced ASN generally includes the carton-level information of a normal ASN along with product-level description of the contents of the cartons. At 930, the enhanced ASN is transmitted to Pool Server 908 at the 3PL.

At 932, a store interface 912 at a retail store optionally generates a request for delivery status. In some embodiments, the request may be a request for status of all pending deliveries to the store associated with a login account. At 934, SMS 906 returns information including a status of the delivery of the portion of the shipment described in the ASN that is destined for the requesting retail store. In general, each ASN will contain cartons destined for multiple retail outlets. The status returned at 934 will contain information regarding the cartons destined for the requesting store, SKU and description information for the contents of the cartons, and an estimated delivery window. In this example, deliveries related to prior ASNs have been completed. However, if other ASNs had been received, the delivery status returned to Store 912 may reflect information about their contents, as well.

SMS 906 may determine the estimated delivery window through a variety of techniques, as described above. SMS 906 may store tables with information related to shipping times from various distribution centers to various pools. These tables may take into account delivery time from the retailer DC to the pool, time at the pool, and time from the pool to the retail location. Restrictions on the days of the week on which deliveries are made or on which the requesting store may receive incoming shipments may also be considered in the calculation of the delivery estimate.

At 936, information extracted by Pool Server 908 from the enhanced ASN is transmitted to Pool Scanner 910 as an “inbound download.” The scanner may be a 1D or 2D barcode scanner, an RFID reader, or other device for detecting identifiers associated with cartons. The inbound download may comprise data, scripts, or programs that provide information about the shipment to the scanner that may be used to provide feedback to an operator. For instance, the inbound download may contain rules, lists of expected cartons, and messages to be presented to the scanner operator. It is to be understood that data for the inbound download may be divided to allow the use of more than one scanner.

At 940, the scanner is used to scan labels or detect tags associated with cartons of the shipment associated with the enhanced ASN. In addition to information regarding which cartons were detected, the scanner may also collect information regarding the timing of the scans, the operator, and other conditions. In some cases, if an ASN was not received at the pool, a “blind scan” may be performed. In a blind scan, cartons are scanned without prior knowledge of whether they were expected in the inbound delivery to the pool.

At 942, at the completion of scanning, or as scanning occurs, information regarding the scanning is transmitted to Pool Server 908 as an “inbound upload.” The information in the inbound upload is compared with information from the enhanced ASN to determine whether extra cartons were received, expected cartons were missing, or received cartons were damaged. This information is optionally sent at 944 to SMS 906 as an “over, short, and damaged” (OS&D) report. In some cases, information regarding missing cartons may be presented to an operator by the scanner or the pool server to allow for correction of the condition before an OS&D report is generated. In a preferred embodiment, an OS&D report is automatically generated in cases where all cartons are accounted for, but manually triggered in cases where there are exceptions.

At 946, another request for delivery status from retail store 912 is received at SMS 906. At 948, SMS 906 replies with information about the cartons that were actually received, which may be different than the cartons specified in the original ASN and reported to the store at 934. The reply may also contain an appropriate updated status, such as “received at pool.” It is to be understood that requests for delivery status from store 912 may be generated automatically on a periodic or aperiodic basis, or may be generated based upon a user request via GUI 300 or other mechanism. Repeated requests within a short period of time, for instance, may return the same status if progress has not been made on the shipment. Delivery status requests may be received on occasions not illustrated in the exemplary sequence diagrams.

The OS&D information may be automatically transmitted to retailer 902 or requested, as shown as request 952 from retailer 902 to SMS 906 and the corresponding reply at 954.

At 958, Pool Server determines a manifest for a particular delivery route including retail store 912. Cartons destined for store 912 for a delivery window encompassing the expected time of the traversal of the route may be included on the manifest. The delivery route may also include other stores for the retailer associated with store 912, as well as stored associated with other retailers. The manifest for the delivery route may include cartons described on other ASNs.

At 960, after a determination has been made at the pool as to which cartons will be loaded onto a particular truck for a delivery route, an “outbound download” is transmitted to a scanner at the pool facility. The outbound download may be delivered over a wired interface, such as USB, via an intermediate scanner dock, or over a wireless network. The outbound download contains information regarding cartons that are to be loaded onto the truck, some of which may be destined for store 912. The outbound download may contain data similar to that of the inbound download described above.

At 962, a scanner 910, which may or may not be the same scanner used at 940, is used to scan cartons during the loading process for the truck. During scanning, the scanning system may alert the operator to exception conditions such as missing or unexpected cartons. Results of the scanning process are transmitted to pool server 908 at 964. The pool server may then produce a report from the outbound upload data and transmit it to SMS 906 at 966.

At 968, manifest information for the delivery is transmitted to delivery scanner 914. The manifest information may contain information regarding the actual bar codes associated with the cartons and the destination for the carton associated with each label. In a preferred embodiment, the information is stored in tabular form. The manifest information transmitted to the delivery scanner may differ from that sent to the outbound scanner in cases where cartons were missing during the outbound scan or other changes were made to the delivery plan. In some cases, scanner 914 may be the same scanner used at 962 for the outbound scan, particularly if the scanner is associated with a particular delivery truck.

In a preferred embodiment, the delivery scanner 914 is also provided with information related to scanning rules, templates, and label formats for particular retailers. In some cases, multiple sets of rules may be used for a particular retailer depending on the store. In some cases, store-related information may include information regarding the scanning of store-location-specific bar codes as a proof-of-presence during the delivery process. In a preferred embodiment, the rules, templates, are formats are also stored in tabular form, as one or more tables.

At 970, another request for delivery status from retail store 912 is received at SMS 906. At 972, SMS 906 replies with information about the cartons that were actually loaded onto the truck for delivery to the requesting store. These cartons may be different than the cartons specified in the original ASN and reported to the store at 934, and may also be different from the cartons specified in the reply at 948, for instance, if there was loss or damage while the shipment was at the pool. The reply may also contain an appropriate updated status, such as “received at pool.”

At 974, cartons are scanned at the retail store during delivery using scanner 914. Software within the scanner compares scanned barcodes or tag IDs with those expected for that store, including both carton labels and store placards or “license plates.” The scanner may alert the delivery person if an unexpected carton is scanned, if an attempt is made to close the delivery without scanning an expected carton, or if procedures are not followed. In some embodiments, multiple scanners may be used during one or more scanning operations.

At 976, information regarding the delivery scan process is transmitted to pool server 908 from scanner 914. Information may be transmitted wirelessly over a wide-area network as the scan is being performed, wirelessly after completion of the entire delivery, or via a wired or wireless interface upon return of the truck and scanner to the pool depot. Transmitted data may comprise raw data regarding the scans or exception data indicating variance from the expected delivery.

At 978, pool server 908 transmits proof-of-delivery information derived from the manifest delivery upload of 976 to SMS 906. SMS 906 may then, at 982, use proof-of-delivery information from one or more deliveries to generate financial or inventory updates for use by retailer 902. For instance, based on proof-of-delivery for a store shipment from SMS 906, a retailers inventory system may be updated to reflect the presence of the delivered items at the destination retail store. As described above, Retailer system 902 and WMS 904 may be combined or spread across multiple compute platforms and either may represent one or more servers or applications.

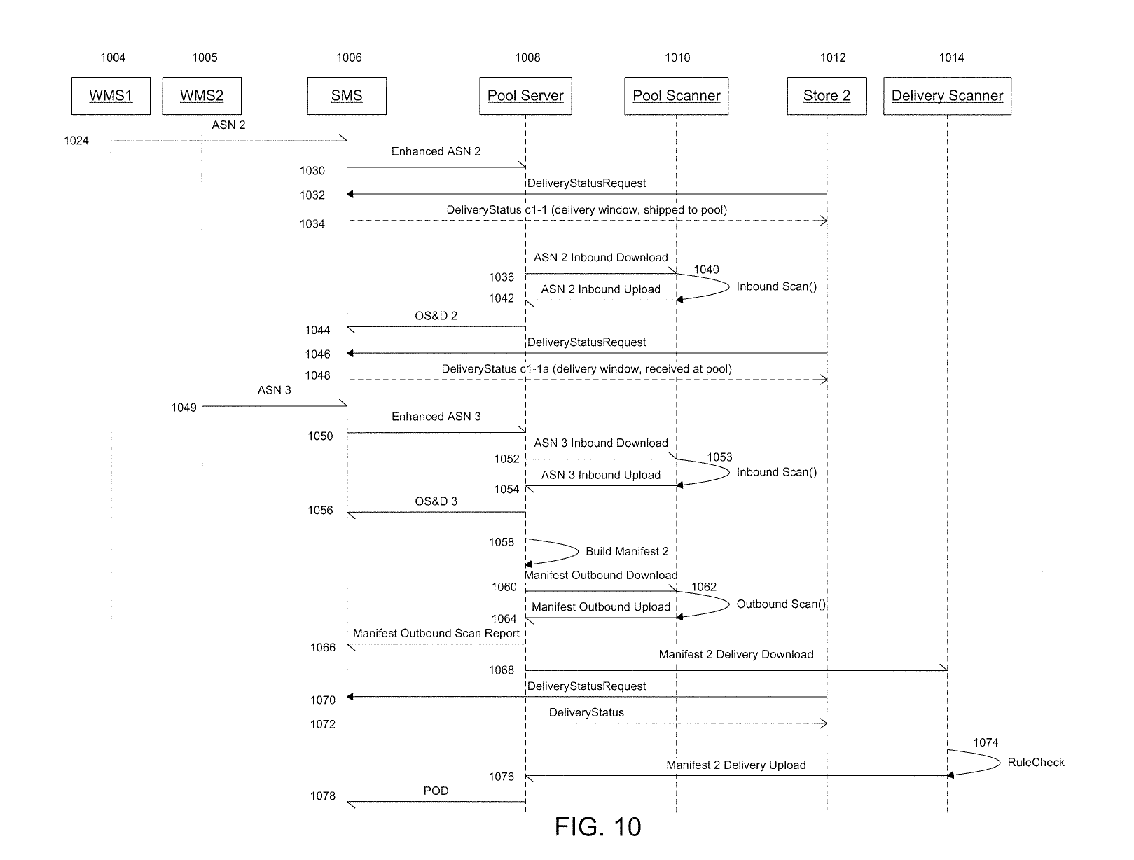

FIG. 10 is a sequence diagram of another delivery scenario. In this exemplary case, cartons from two separate ASNs are combined at the pool and delivered to the retail store. Steps described in FIG. 9, such as delivery of the product file from the retailer to the SMS are assumed to have already occurred. Other steps, such as application of the product file to produce enhanced ASNs, are omitted in this example for clarity.

At 1024, the ASN for a shipment is transmitted to SMS 1006. The ASN preferably comprises SKU information for the contents of the described cartons. In some embodiments, SKU information may be transmitted directly to SMS 1006 for combination with a received ASN. SMS 1006 may combine product information with the received ASN to produce an enhanced ASN, as described above with respect to FIG. 9. At 1030, the enhanced ASN is transmitted to Pool Server 1008 at the 3PL.

At 1032, a store interface 1012 at a retail store optionally generates a request for delivery status. In some embodiments, the request may be a request for status of all pending deliveries to the store associated with a login account. At 1034, SMS 1006 returns information including a status of the delivery of the portion of the shipment described in the ASN that is destined for the requesting retail store. In general, each ASN will contain cartons destined for multiple retail outlets. The status returned at 1034 will contain information regarding the cartons destined for the requesting store, SKU and description information for the contents of the cartons, and an estimated delivery window. Since information about the cartons is known, but the cartons have not yet been received at the pool, the status may also contain a descriptor such as “shipped to pool.” SMS 1006 may determine the estimated delivery window as described above with respect to FIG. 9.

At 1036, information extracted by Pool Server 1008 from the enhanced ASN is transmitted to Pool Scanner 1010 as an “inbound download.” Aspects of the inbound download are described above with respect to FIG. 9. At 1040, the scanner is used to scan labels or detect tags associated with cartons of the shipment associated with the enhanced ASN. At the completion of scanning, or as scanning occurs, information regarding the scanning is transmitted to Pool Server 1008 as an “inbound upload.” The information in the inbound upload is compared with information from the enhanced ASN to determine whether extra cartons were received, expected cartons were missing, or received cartons were damaged. This information is optionally sent at 1044 to SMS 1006 as an “over, short, and damaged” (OS&D) report.

At 1046, another request for delivery status from retail store 1012 is received at SMS 1006. At 1048, SMS 1006 replies with information about the cartons that were actually received, which may be different than the cartons specified in the original ASN and reported to the store at 1034. The reply may also contain an appropriate updated status, such as “received at pool.” At this point in time, in this example, the status provided to the store reflects only those cartons destined for the store from enhanced ASN 2 of 1030.

At 1049, another ASN is transmitted from a second WMS 1005 to SMS 1006. Like the ASN transmitted from WMS 1004 at 1024, this ASN also references cartons destined for Store 1012. It is to be understood that while in this example, two different WMS servers are described, the functions of both may actually be provided by one unified warehouse management system for the retailer that is used to operate multiple distribution centers.

While not shown, it is possible that Store 1012 would request delivery status at this point, after receipt of both ASNs, but physical receipt of only the shipment related to the first. In such a case, Pool Server 1008 would respond with a delivery status comprising the actual received cartons from the ASN from 1024 and the expected cartons from the ASN from 1049. In a preferred embodiment, the status related to the delivery would be the status related to the ASN that is furthest along in the shipment process. In this case, the status would be “received at pool,” representing the fact that the shipment related to the ASN of 1024 was physically received, and despite the fact that the shipment related to the ASN of 1049 has not been physically received. In other embodiments, separate or hybrid statuses could be provided representing the different progress of the different shipments.

At 1052, information extracted by Pool Server 1008 from the enhanced ASN is transmitted to Pool Scanner 1010 as an “inbound download.” At 1053, the scanner is used to scan labels or detect tags associated with cartons of the shipment associated with the enhanced ASN. At 1054, at the completion of scanning, or as scanning occurs, information regarding the scanning is transmitted to Pool Server 1008 as an “inbound upload.” The information in the inbound upload is compared with information from the enhanced ASN to determine whether extra cartons were received, expected cartons were missing, or received cartons were damaged. This information is optionally sent at 1056 to SMS 1006 as an “over, short, and damaged” (OS&D) report.

A function of the pool is to combine such cartons from multiple inbound shipments onto combined outbound delivery trucks. This increases shipping efficiency and reduces the number of deliveries to a particular store. In this example, both the ASN transmitted to SMS 1006 at 1024 and the ASN transmitted to SMS 1006 at 1049 refer to cartons for delivery to store 1012 during common overlapping delivery windows. Using software on Pool Server 1008, separate software, or a manual process, at 1058, Pool Server determines a manifest for a particular delivery route including retail store 1012. Appropriate cartons destined for store 1012 from both the ASN of 1024 and the ASN of 1049 may be included on the manifest.

At 1060, after the determination has been made at the pool as to which cartons will be loaded onto a particular truck for a delivery route, an “outbound download” is transmitted to a scanner at the pool facility. The outbound download may be delivered over a wired interface, such as USB, via an intermediate scanner dock, or over a wireless network. The outbound download contains information regarding cartons that are to be loaded onto the truck, some of which may be destined for store 1012.

At 1062, a scanner 1010, which may or may not be the same scanner used at 1040, is used to scan cartons during the loading process for the truck. Results of the scanning process are transmitted to pool server 1008 at 1064. The pool server may produce a report from the outbound upload data and transmit it to SMS 1006 at 1066.

At 1068, manifest information for the delivery is transmitted to delivery scanner 1014. In some cases, scanner 1014 may be the same scanner used at 1062 for the outbound scan, particularly if the scanner is associated with a particular delivery truck. The manifest download may be structured in tables as described above with respect to FIG. 9.

At 1070, another request for delivery status from retail store 1012 is received at SMS 1006. At 1072, SMS 1006 replies with information about the cartons that were actually loaded onto the truck for delivery to the requesting store. In this example, the list of cartons will be different than the list of cartons specified in the original ASN and reported to the store at 1034 and 1048 do to the intervening receipt of the cartons of ASN 3. Thus, the system provides the store with up-to-date delivery information to account for later shipments from another distribution center to the pool. The reply may also contain an appropriate updated status, such as “out for delivery.”

At 1074, cartons are scanned at the retail store during delivery using scanner 1014. At 1076, information regarding the delivery scan process is transmitted to pool server 1008 from scanner 1014. At 1078, pool server 1008 transmits proof-of-delivery information derived from the manifest delivery upload of 1076 to SMS 1006. SMS 1006 may then transmit financial, inventory, or other status back to the retailer. Each of these operations are described in greater detail above with respect to FIG. 9.

In a preferred embodiment, requests to the SMS 210 from the Retail Interface 210, or from a retailer or management interface, are made in the form of a query string, possible sent as part of a URL. Responses from the SMS to the Retail Interface 210 or other interface are preferably in the form of XML data.

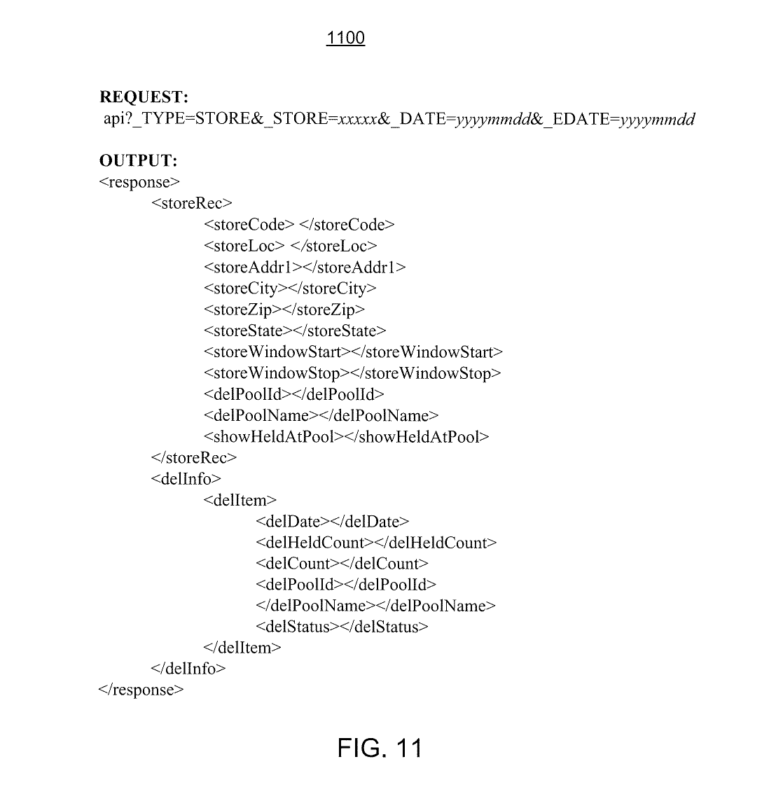

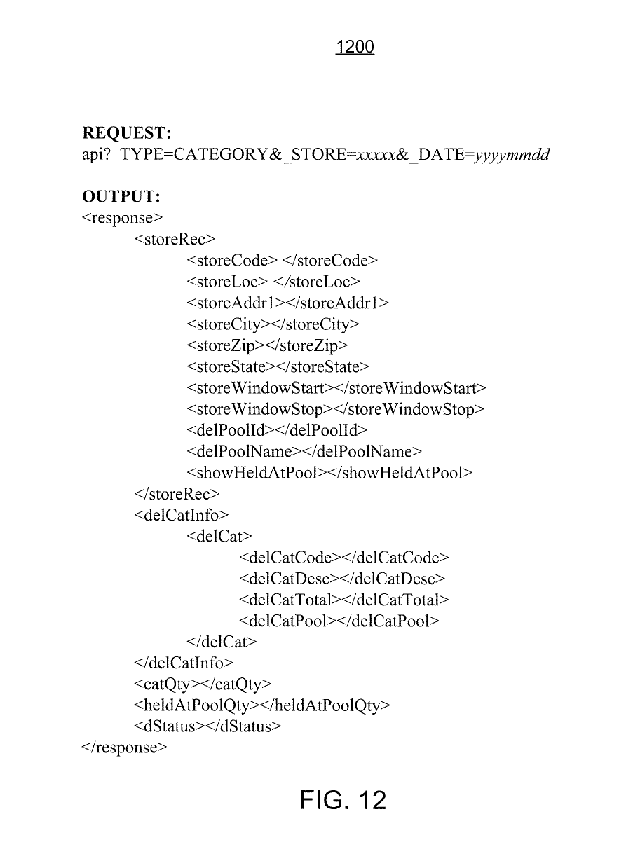

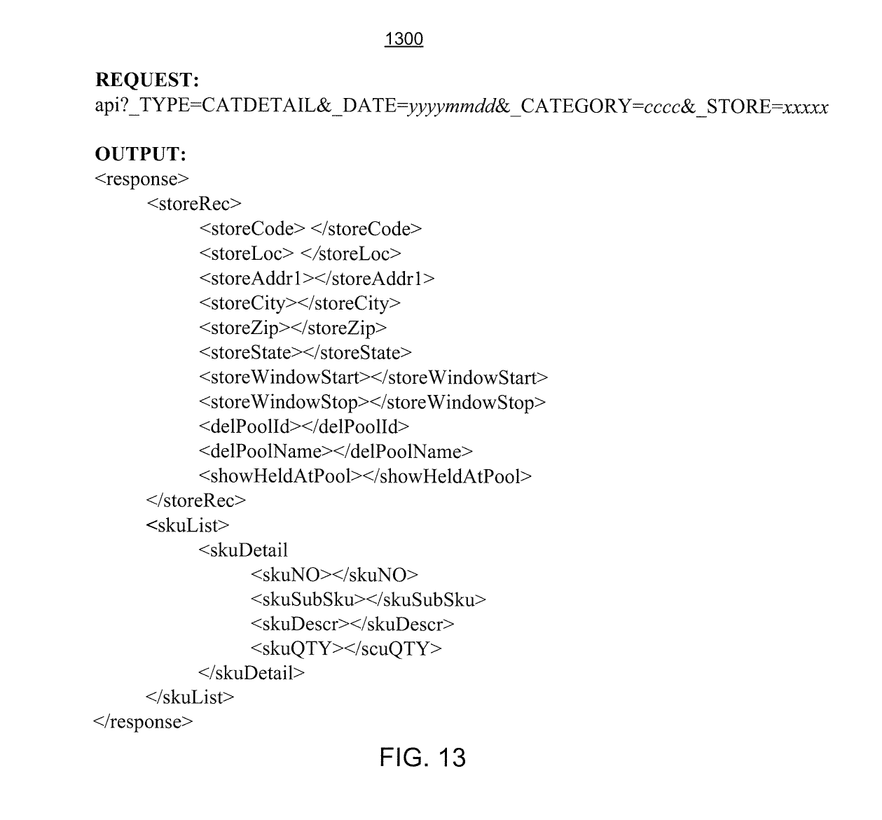

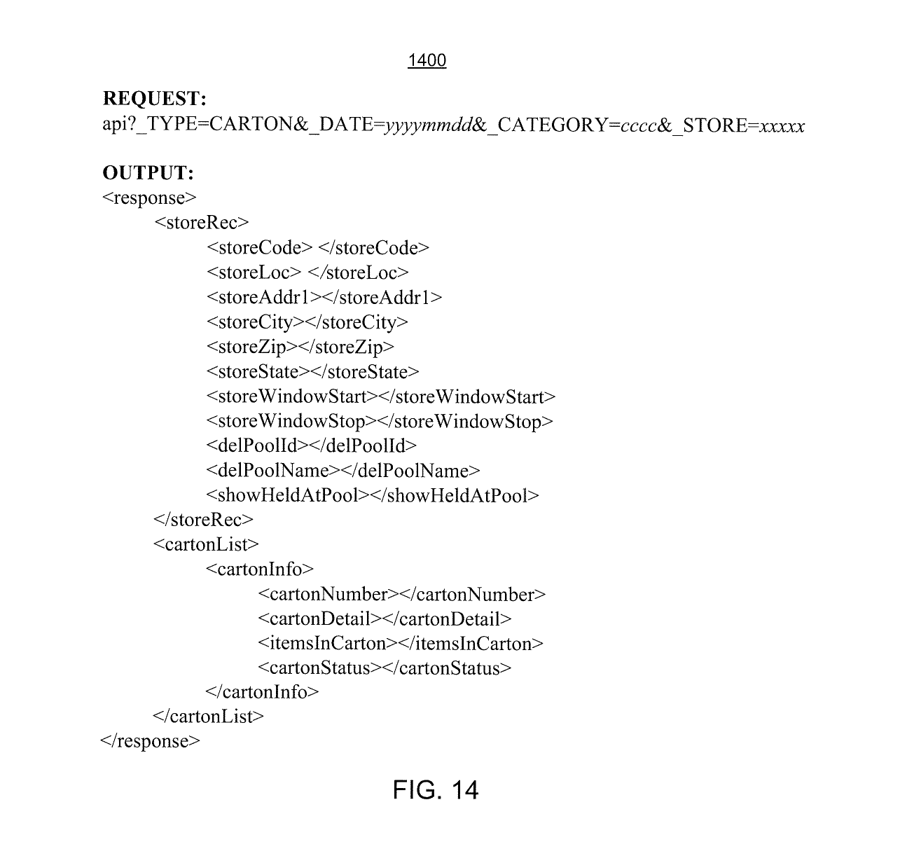

FIG. 11 provides an example query string and format for an XML response for a listing of the deliveries for a store. FIG. 12 provides an example query string and format for an XML response for a listing of the categories of goods being delivered to a store on a particular day. FIG. 13 provides an example query string and format for an XML response for a listing of SKUs to be delivered on a specific day for a specified category. FIG. 14 provides an example query string and format for an XML response for a listing of cartons to be delivered on a specific day for a specified category. Additional queries may provide, for instance, a list of stores for which a login account is authorized, a list of cartons that contain a specified SKU, or the product contents of a particular carton.

In some cases, a retail store may have a need to transfer cartons to another retail store or back to a distribution center. Transferring these cartons using the delivery mechanisms in place for normal deliveries may provide cost and/or time advantages over using a separate service such as UPS or FedEX. The SMS 210 may provide functionality to arrange and track these transfers.

In a preferred embodiment, SMS 210 provides a web interface over the Internet, or other network, for entering transfer requests. The transfer interface may preferably be presented as a separate portion of the site used for tracking normal deliveries, such as a specific tab or page. To initiate a transfer, an employee at the retail outlet may enter information such as an identifier related to the destination store, a document number or other identifier related to the transfer, the number of cartons in the transfer, a category for the transfer, and information regarding the contents of the cartons to be transferred. The request for carton transfer is then transmitted from the sending retail location to the shipment management server.

SMS 210 may then respond by sending data comprising label information to the sending retail location. In a preferred embodiment, the label information may be a PDF file formatted for printing on label stock at the retail location. The retail employee may then print and apply the labels to the cartons to be transferred. The labels may include bar codes of a form used for normal deliveries or specially formatted barcodes used for transfers.

A notification of the transfer may be sent to the pool provider either by the retail interface or SMS 210. During a next scheduled delivery or special pickup, the cartons to be transferred may be provided to the delivery person from the pool provider. Scanning rules downloaded to the delivery scanner may include rules to allow pickup of cartons with barcodes indicating the carton is being transferred. The cartons to be transferred may generally be brought back to the pool provider location, scanned during a pool receive scan, sorted, and delivered as a part of normal deliveries.

An employee at the retail location receiving the transfer may access a portion of a portal provided by SMS 210 to check the status of normal deliveries or transfers. Upon receiving a request for delivery information or carton transfer information from the receiving retail location, SMS 210 may send some or all of the information provided by the sending retail location. Information regarding the transfer may preferably include an estimated delivery date and may appear both on status pages for normal deliveries and for transfers.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

For instance, status updates to retail stores have been described as a “pull” model, where software at the store sends a request to the SMS. In embodiments of the system and associated methods, the SMS may use “push” notification techniques to inform stores of changes to delivery status or contents. One or more scanners may be used for each scanning function. Scanners for certain functions may be entirely separate or overlap those used for other functions. As described above, scanners may use wired or wireless methods to receive manifest and delivery information and transmit scanning results. Results may be transmitted as scanning is performed or batched. Comparison of scanning input with rules and manifest information may be performed locally at the scanner or on a remote computing platform, for instance, the Pool Server.

OS&D, POD, and other reports may be delivered using either push or pull models. Delivery of certain reports may be dependent on user preference or configuration. WMS, SMS, and Pool servers may run on single machines or be distributed across multiple machines. In particular, database and web serving functions may be distributed to separate compute platforms within the scope of the present disclosure.

We claim:

1. A method for tracking and displaying delivery status information comprising:
(a) receiving, by one or more processors associated with a retail location, from a shipment management system (SMS) server, first delivery status information including:
(i) first carton information regarding cartons to be delivered to the retail location in a first delivery, the first carton information being derived, at least in part, from a first advance shipping notice received by the SMS server from a first warehouse management system (WMS) server;
(ii) first item information regarding items within each carton; and
(iii) a delivery window;
(b) receiving, by the one or more processors, second delivery status information including second carton information regarding cartons to be delivered to the retail location in the first delivery, the second carton information being derived, at least in part, from a second advance shipping notice received by the SMS server from a second WMS server;
(c) processing, by the one or more processors, the received first and second delivery status information; and
(d) simultaneously displaying, by a display screen in communication with the one or more processors, the processed first and second delivery status information.

2. The method of claim 1, wherein the first item information includes at least one of:
a stock keeping unit (SKU) of items within each carton, and
a category of items within each carton.

3. The method of claim 1, wherein the first delivery status information further includes a first delivery status.

4. The method of claim 3, wherein the first delivery status includes information indicative of reception of a first shipment at a pool shipment location, the first shipment being related to the first advance shipping notice and including cartons to be delivered to the retail location in the first delivery.

5. The method of claim 1, wherein the first delivery status information includes information indicative of whether the first delivery has left a pool shipment location.
